(19) United States
(12) Patent Application Publication
(10) Pub. No.: US 2012/0043793 A1
(43) Pub. Date: Feb. 23, 2012

(54) TRANSPORTABLE SAFETY SEAT

(76) Inventor: MARY KATHLEEN RODEN, LAKE ST. LOUIS, MO (US)

(21) Appl. No.: 12/860,911

(22) Filed: Aug. 22, 2010

(51) Int. Cl. B60N 2/24

(52) U.S. Cl. 297/250.1

(57) ABSTRACT

A transportable safety seat comprising a back support to brace against a back rest of a vehicle seat, a seat extending laterally from a bottom portion of the back support, a headrest extending from a top portion of the back support, a neck pillow placed in front of the headrest stretching across the top portion of the back support, a pair of straps reaching across the back support, and a set of upper Velcro pads attached to an upper end of the pair of straps and a set of lower Velcro pads attached to a lower end of the pair of straps wherein the lower set of Velcro pads secure behind the back support to permit the pair of straps to stretch across the back support without shifting, and finally the upper set of Velcro pads grip behind the back support.

### BACKGROUND OF THE INVENTION

1. Field of the Invention

The present invention relates to a seat belt apparatus to enable a person with disabilities to sit upright in a seat and travel safely in a vehicle by preventing them from slouching or shifting while seated.

2. Description of Related Art

There have been many developments made to assist and accommodate persons with disabilities, specifically those confined to a wheelchair. Ramps have been installed at public buildings to allow access to the front entrances, vehicles with lifting mechanisms to load the wheelchair into the cabin, and even hand controls to enable a person without the use of their legs to drive a car. All of these devices and accommodations better enable the wheelchair bound person to live more normal lives. While the severity of the disability ranges, modifications continuously develop to be adjusted for the needs of the specific person.

An area of concern for a person with limited motor control is how they are transported in a vehicle. Some people are unable to sit upright without assistance thus additional devices are needed for support. Some devices may strap or brace the person into a car seat so that they are safe and secure while traveling. The devices may enable the person to sit upright without falling forward, so that they are secure within their seat. But, in general, these devices are bulky and cumbersome to move, and more often than not difficult to adjust while the person is seated. This is a problem for the caretakers because they are responsible for moving the person and loading and unloading the safety harness. With all of the other tasks the caretaker must perform, a large and bulky harness should be the least of their worries.

It would be desirable to have a device that enables a person unable to sit upright on their own while traveling in a vehicle that is easily transportable. It would also be beneficial to have a device which may be easily folded or rolled to transport the device from one location to another.

### SUMMARY OF THE INVENTION

The present invention provides a transportable safety seat comprising a back support to brace against a back rest of a vehicle seat, a seat extending laterally from a bottom portion of the back support, a headrest extending from a top portion of the back support, a neck pillow placed in front of the headrest stretching across the top portion of the back support, a pair of straps reaching across the back support, and a set of upper Velcro pads attached to an upper end of the pair of straps and a set of lower Velcro pads attached to a lower end of the pair of straps wherein the lower set of Velcro pads secure behind the back support to permit the pair of straps to stretch across the back support without shifting, and finally the upper set of Velcro pads grip behind the back support.

Another object of the present invention is to provide a transportable safety seat which rolls or folds upon itself to enable the transportable safety seat to be carried from one location to another.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 depicts a perspective view of a transportable safety seat in accordance with an exemplary embodiment of the present invention; and

FIG. 2 depicts a backside view of a transportable safety seat in accordance with an exemplary embodiment of the present invention.

Like reference numerals refer to like parts throughout the description of several views of the drawings.

### DETAILED DESCRIPTION OF THE DRAWINGS

The present invention relates to a transportable safety seat to enable a person or patient without the ability to sit upright to travel safely in a vehicle. The transportable safety seat ensures that an individual with physical limitation is seated comfortably and in a safe manner while traveling. The device is comprised of adjustable straps to cross the person's torso, as well as Velcro fasteners to attach to a back support of the device. The straps and Velcro pads may be adapted for a customized fit around the person. The transportable safety seat is easy to use, and designed specifically for easy transport and adjustments.

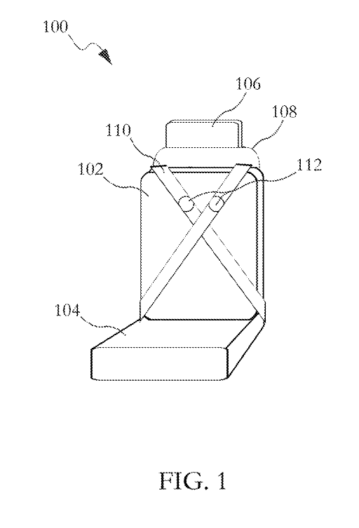

Turning now descriptively to the drawing, referring to FIG. 1, a perspective view of a transportable safety seat (100) is shown in accordance with an exemplary embodiment of the present invention. The transportable safety seat (100) includes a back support (102), a seat (104) and a headrest (106). The back support (102) may rest against a backrest of a vehicle seat, and may include a soft sponge pad with a cloth, leather, or vinyl casing or covering depending on the preferences of a user. The back support (102) offers a soft and comfortable cushion for a user to lean back against while seated. The seat (104) may be made from another sponge pad and covered with the coordinating material as the back support (102). During transportation, the seat (104) may fold against the back support (102) for a more compact design.

The headrest (106) extends from a top portion of the back support (102). The headrest (106) may extend and lower within the back support to adjust the headrest (106) to meet user's head. In front of the headrest (106), above the back support (102), may be a neck pillow (108). The neck pillow (108) may provide the user with a soft and cozy support to rest their head while seated on the transportable safety seat (100). The neck pillow (108) may assist the user to hold up their head if movement of their neck is not completely under their own control. Extending below the neck pillow (108), from the top of the back support (102), is a pair of straps (110) (hereinafter straps). The straps (110) may stretch diagonally across the user's chest and intersect in the middle to brace the user against the back support (102). The straps (110) prevent the user from slumping in the seat of the vehicle, and enable them to sit upright and comfortable while traveling. The straps (110) may have an adjuster to adjust the length of the straps for a customized fit against the user's chest. The adjuster (112) may be a slide mechanism like those found in a seat belt to extend and shorten the straps (110).

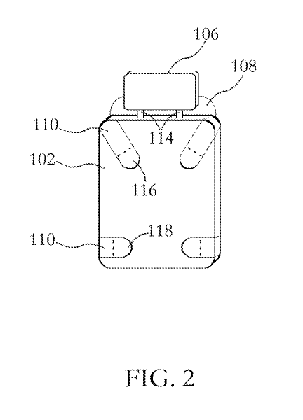

Referring to FIG. 2, a backside view of the transportable safety seat (100) is shown in accordance with an exemplary embodiment of the present invention. FIG. 2 illustrates how the headrest (106) may have a pair of extenders (114) to raise and lower the headrest (106) within the back support. The extenders (114) may have a tight sliding mechanism or a set of adjustment notches to allow the headrest (106) to stay in place once adjusted to fit the height of the user's head. The straps (110) may have an upper end with a coordinating upper velcro pad (116) and a lower end with a coordinating lower Velcro pad (118). The lower Velcro pad (118) may be placed first, and then the upper Velcro pad (116) may be secured against the backside of the back support (102) after extending the strap (110) across the user's torso. The Velcro pads (116 and 118) may be adjusted and readjusted until an ideal fit is attained and the user is securely strapped into the transportable safety seat (100). Finally, a passenger seat belt may be placed across the user's chest thus with all the straps and belts properly in place the user is prevented from shifting, falling or slouching while riding in a vehicle.

The transportable safety seat (100) may be folded upon itself when relating the device from one vehicle to another. First, the headrest (106) may be removed and set aside. Then the seat (104) may fold up against the back support (102), and then the back support (102) may fold again over the seat (104) to create a C-fold orientation. Alternatively, the seat (104) and the back support (102) may be rolled similarly to a sleeping bag. Finally, the straps (110) may wrap around the rolled seat (104) and back support (102) and then secure the roll in place with the Velcro pads (116 and 118).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A transportable safety seat comprising:
a back support to brace against a back rest of a vehicle seat;
a seat extending laterally from a bottom portion of said back support;
a headrest extending from a top portion of said back support;
a neck pillow placed in front of said headrest stretching across said top portion of said back support;
a pair of straps reaching across said back support; and
a set of upper Velcro pads attached to an upper end of said pair of straps and a set of lower Velcro pads attached to a lower end of said pair of straps wherein said lower set of Velcro pads secure behind said back support to permit said pair of straps to stretch across said back support without shifting, and finally said upper set of Velcro pads grip behind said back support to enable a person to sit in said transportable safety seat without slouching and shifting in said vehicle seat.

2. The transportable safety seat of claim 1, wherein said seat folds against said back support and said back support folds over said seat to create a C-fold arrangement secured with said pair of straps.

3. The transportable safety seat of claim 1, wherein said seat rolls up to include said back support to create a roll and said roll is secured with said pair of straps.

4. The transportable safety seat of claim 1, wherein said headrest raises and lowers on a pair of extenders attached within said upper portion of said back support.

5. The transportable safety seat of claim 1, wherein said back support and said seat are covered in a leather casing.

6. The transportable safety seat of claim 1, wherein said back support and said seat are covered in a cloth casing.
